(19) United States
(12) Patent Application Publication
(10) Pub. No.: US 2013/0155178 A1
(43) Pub. Date: Jun. 20, 2013

(54) Controlling a Camera Using a Touch Interface

(71) Applicants: Wayne E. Mock, Round Rock, TX (US); Patrick R. McKinnon, Austin, TX (US)

(72) Inventors: Wayne E. Mock, Round Rock, TX (US); Patrick R. McKinnon, Austin, TX (US)

(21) Appl. No.: 13/328,033

(22) Filed: Dec. 16, 2011

(51) Int. Cl. H04N 7/15; H04N 5/262

(52) U.S. Cl. 348/14.08; 348/240.2; 348/E05.055; 348/E07.083

(57) ABSTRACT

Controlling a camera using a touch interface. A first input control and a second input control may be presented on a touch interface. The first input control may be configured to control pan and tilt of the camera and the second input control may be configured to control zoom of the camera. First user input may be received to the touch display to a first region of one of the input controls. After, second user input may be received to the touch display to a second region outside of the first region. The pan and tilt or the zoom of the camera may be adjusted in response to the second user input.

### FIELD OF THE INVENTION

The present invention relates generally to camera control and, more specifically, to a system and method for controlling a camera using a touch interface.

### DESCRIPTION OF THE RELATED ART

Videoconferencing may be used to allow two or more participants at remote locations to communicate using both video and audio. Each participant location may include a videoconferencing system for video/audio communication with other participants. Each videoconferencing system may include a camera and microphone to collect video and audio from a first or local participant to send to one or more other (remote) participants. Each videoconferencing system may also include a display and speaker to reproduce video and audio received from remote participant(s). Each videoconferencing system may also be coupled to a computer system to allow additional functionality into the videoconference. For example, additional functionality may include data conferencing (including displaying and/or modifying a document for both participants during the conference).

Initial videoconferencing systems generally used a remote control to control videoconferencing functionality, such as camera control in the videoconference. However, as videoconferencing has become more prevalent, the number of desired and supported features has increased greatly. Unfortunately, the interfaces used to control videoconferences have not been able to keep up the increase in features, leading to a confusing and inefficient user interaction. Similar issues have arisen in other fields which include camera control. Accordingly, improvements in user interactions, e.g., related to camera control, are desired, particularly in the area of videoconferencing.

### SUMMARY OF THE INVENTION

Various embodiments are presented of a system and method for controlling a camera using a touch display.

A first input control and a second input control may be presented on the touch display. For example, each input control may be represented by an icon (e.g., a circular icon) on the touch display. The first input control may be configured to control pan and tilt of the camera while the second input control may be configured to control zoom of the camera.

In some embodiments, the camera being controlled may have been previously selected from a plurality of available camera for control. For example, a user interface may have been displayed on the touch display for selecting a camera to control and user input may be received to the user interface to select the camera. The list of available cameras may include one or more local cameras (e.g., at the same location as the touch display) and/or one or more remote cameras (e.g., provided at remote locations, such as in other videoconferencing endpoints participating in a videoconference). Accordingly, the first and second input controls may be presented in response to the selection of the camera. Note that the camera controls may be presented during a videoconference or at other times, as desired.

Each of the first input control and the second input control may include a first region for activating the respective control. For example, the first region may be the interior of the input control's icon. In some embodiments, the first region may be all of the interior of the input control icon or may be a subset of the interior (e.g., the centermost 50% the icon), as desired. Additionally, after activation (e.g., via the user touching and holding contact within the first region), the input controls may include a second region for performing camera control, e.g., controlling the pan and tilt or zoom of the camera, depending on the activated input control. In one embodiment, user input to the second regions may not perform any action unless the input control has been activated. Similarly, user input to the second regions may not perform any action if the input control has been deactivated. Thus, in one embodiment, the second regions may only receive input to perform camera control while the selected input control is activated. In some embodiments, the second region may be the area immediately exterior to the first region (e.g., outside of the icon representing the control). The second region may only extend a certain amount from the first region (e.g., the area of the second region may be 50% or 100% more than the first region) or may be any region outside of the first region, as desired.

The second region may include a plurality of subregions for performing the particular camera control functions associated with the input control. For example, the first input control may have four subregions: two for controlling pan (e.g., extending to the left and right from the first region, respectively) and two for controlling tilt (e.g., extending up and down from the first region, respectively). Similarly, for the second input control, there may be two subregions for controlling zoom of the camera, e.g., extending up and down from the first region, respectively, or extending left and right from the first region, respectively. The subregions of the second region may be contiguous (that is, the subregions may all directly border each other and their combined area may be the same as the second region's area) or they may not (e.g., where the second region includes “dead” areas between the subregions which do not activate camera control), as desired.

Accordingly, first user input may be received to the touch display to activate one of the inputs controls. For example, to activate one of the controls, the user may provide the user input to the first region of the input control. In one particular embodiment, to activate the input control, the user may touch the first region (e.g., with a single touch) of the input control and remain touching the touch display. In such an embodiment, the input control may remain activated while the user remains touching the touch display and stays within the first region and/or the second region of the input control. Thus, in this embodiment, the input control may be deactivated if the user ceases touching the touch display and also may be deactivated if the user's touch input moves outside of the first and second regions of the selected input control. Alternatively, the input control may remain activated while the touch continues and may not be dependent on the particular location of the touch. However, this particular activation/deactivation embodiment is exemplary only and others are envisioned. For example, a single touch may activate the control and then later input could be received to the second regions after activation. Additionally, various gestures may be used to activate or deactivate the input controls, as desired.

When activated, a visual indication that the input control is activated may be provided on the touch display. For example, the touch display may visually indicate that the selected input control has been activated by modifying the icon representing the selected input control. In one embodiment, this may be indicated by highlighting the icon or otherwise modifying the icon's appearance (e.g., enlarging the icon, animating the icon, etc.). In addition, other visual indicators may be displayed on the touch display, such as additional icons (e.g., a selection icon indicating that the input control is activated). Further, visual indicators of the second region (e.g., the subregions of the second region) may be provided on the touch display, e.g., in order to instruct the user on how to perform the camera control using the second region. For example, arrows or other icons may be displayed within the subregions to indicate the actions that may be performed in response to touches to those subregions.

After receiving the first user input, second user input may be received to the touch display to the second region of the selected input control. More specifically, the second user input may be received to one or more of the subregions of the second region. For example, when using the first input control, the user may wish to pan the camera left and tilt the camera down—accordingly, the second user input may be received first to the left subregion and then to the down subregion (although one or more of these may be the opposite, depending on whether input inversion is used). Similarly, the user may provide input to the second input control for controlling the zoom or magnification of the camera.

Note that the first and second user input may be continuous input (where the touch is not released), e.g., following the embodiment described above. However, as also indicated above, disparate inputs are also envisioned, e.g., for other activation/deactivation embodiments, as desired. Similarly, the second input to the subregions may comprise a single continuous input (e.g., where the user does not lift or cancel the initial touch) or may comprise several disparate inputs (e.g., to each subregion), as desired.

Accordingly, based on the second user input, the pan and tilt or the zoom of the camera may be adjusted, depending on which of the first input control or the second input control is selected. Since the second user input may be continuous (e.g., selecting a first subregion and then a second subregion), the adjustment of the camera may be performed similarly, e.g., reacting as soon as the touch input is within a subregion.

In some embodiments, the camera may be controlled in a linear fashion, where each increment of time for a touch results in a similar level of adjustment. However, different relationships are envisioned, e.g., where the level of adjustment increases over time (e.g., where the rate of change in the camera control function increases the longer the touch is held in a subregion), where the level of adjustment decreases over time, where the level of adjustment is based on the camera's current position relative to its extrema (e.g., where zooming slows down as it approaches its maximum or minimum zoom), etc. Thus, any type of responsiveness for the adjustment is envisioned.

### BRIEF DESCRIPTION OF THE DRAWINGS

A better understanding of the present invention may be obtained when the following detailed description is considered in conjunction with the following drawings, in which:

FIG. 1 illustrates an exemplary videoconferencing system participant location, according to an embodiment;

FIGS. 2A and 2B illustrate exemplary conferencing systems coupled in different configurations, according to some embodiments;

FIG. 3A illustrates an exemplary touch interface, according to one embodiment; and

FIG. 3B illustrates an exemplary phone with a touch interface, according to one embodiment;

FIG. 4 is a flowchart diagram illustrating an embodiment of a method for controlling a camera using a touch interface; and

FIGS. 5-7H illustrate exemplary interfaces for controlling the camera using the touch interface, according to one embodiment.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. Note the headings are for organizational purposes only and are not meant to be used to limit or interpret the description or claims. Furthermore, note that the word “may” is used throughout this application in a permissive sense (i.e., having the potential to, being able to), not a mandatory sense (i.e., must). The term “include”, and derivations thereof, mean “including, but not limited to”. The term “coupled” means “directly or indirectly connected”.

### DETAILED DESCRIPTION OF THE EMBODIMENTS

### Incorporation by Reference

U.S. patent application titled “Video Conferencing System Transcoder”, Ser. No. 11/252,238, which was filed Oct. 17, 2005, whose inventors are Michael L. Kenoyer and Michael V. Jenkins, is hereby incorporated by reference in its entirety as though fully and completely set forth herein.

U.S. patent application titled “Virtual Decoders”, Ser. No. 12/142,263, which was filed Jun. 19, 2008, whose inventors are Keith C. King and Wayne E. Mock, is hereby incorporated by reference in its entirety as though fully and completely set forth herein.

U.S. patent application titled “Video Conferencing Device which Performs Multi-way Conferencing”, Ser. No. 12/142,340, whose inventors are Keith C. King and Wayne E. Mock, is hereby incorporated by reference in its entirety as though fully and completely set forth herein.

U.S. patent application titled “Conferencing System Utilizing a Mobile Communication Device as an Interface”, Ser. No. 12/692,915, whose inventors are Keith C. King and Matthew K. Brandt, is hereby incorporated by reference in its entirety as though fully and completely set forth herein.

U.S. patent application titled “Controlling a Videoconference Based on Context of Touch-Based Gestures”, Ser. No. 13/171,292, which was filed on Jun. 28, 2011, whose inventor is Wayne E. Mock is hereby incorporated by reference in its entirety as though fully and completely set forth herein.

### TERMS

The following is a glossary of terms used in the present application:

Memory Medium—Any of various types of memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; or a non-volatile memory such as a magnetic media, e.g., a hard drive, or optical storage. The memory medium may comprise other types of memory as well, or combinations thereof. In addition, the memory medium may be located in a first computer in which the programs are executed, or may be located in a second different computer which connects to the first computer over a network, such as the Internet. In the latter instance, the second computer may provide program instructions to the first computer for execution. The term “memory medium” may include two or more memory mediums which may reside in different locations, e.g., in different computers that are connected over a network.

Carrier Medium—a memory medium as described above, as well as a physical transmission medium, such as a bus, network, and/or other physical transmission medium that conveys signals such as electrical, electromagnetic, or digital signals.

Computer System—any of various types of computing or processing systems, including a personal computer system (PC), mainframe computer system, workstation, network appliance, Internet appliance, personal digital assistant (PDA), smart phone, television system, grid computing system, or other device or combinations of devices. In general, the term “computer system” can be broadly defined to encompass any device (or combination of devices) having at least one processor that executes instructions from a memory medium.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

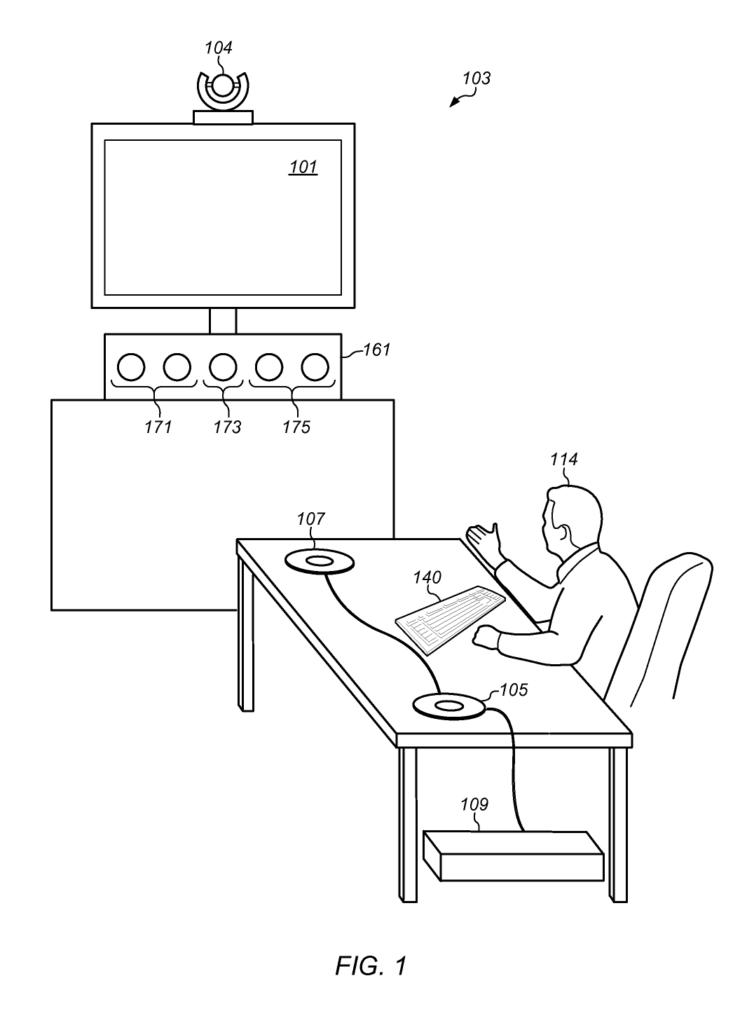

FIG. 1—Exemplary Participant Locations

FIG. 1 illustrates an exemplary embodiment of a videoconferencing participant location, also referred to as a videoconferencing endpoint or videoconferencing system (or videoconferencing unit). The videoconferencing system 103 may have a system codec 109 to manage both a speakerphone 105/107 and videoconferencing hardware, e.g., camera 104, display 101, speakers 171, 173, 175, etc. The speakerphones 105/107 and other videoconferencing system components may be coupled to the codec 109 and may receive audio and/or video signals from the system codec 109.

In some embodiments, the participant location may include camera 104 (e.g., an HD camera) for acquiring images (e.g., of participant 114) of the participant location. Other cameras are also contemplated. The participant location may also include display 101 (e.g., an HDTV display). Images acquired by the camera 104 may be displayed locally on the display 101 and/or may be encoded and transmitted to other participant locations in the videoconference. In some embodiments, images acquired by the camera 104 may be encoded and transmitted to a multipoint control unit (MCU), which then provides the encoded stream to other participant locations (or videoconferencing endpoints).

The participant location may further include one or more input devices, such as the computer keyboard 140. In some embodiments, the one or more input devices may be used for the videoconferencing system 103 and/or may be used for one or more other computer systems at the participant location, as desired.

The participant location may also include a sound system 161. The sound system 161 may include multiple speakers including left speakers 171, center speaker 173, and right speakers 175. Other numbers of speakers and other speaker configurations may also be used. The videoconferencing system 103 may also use one or more speakerphones 105/107 which may be daisy chained together.

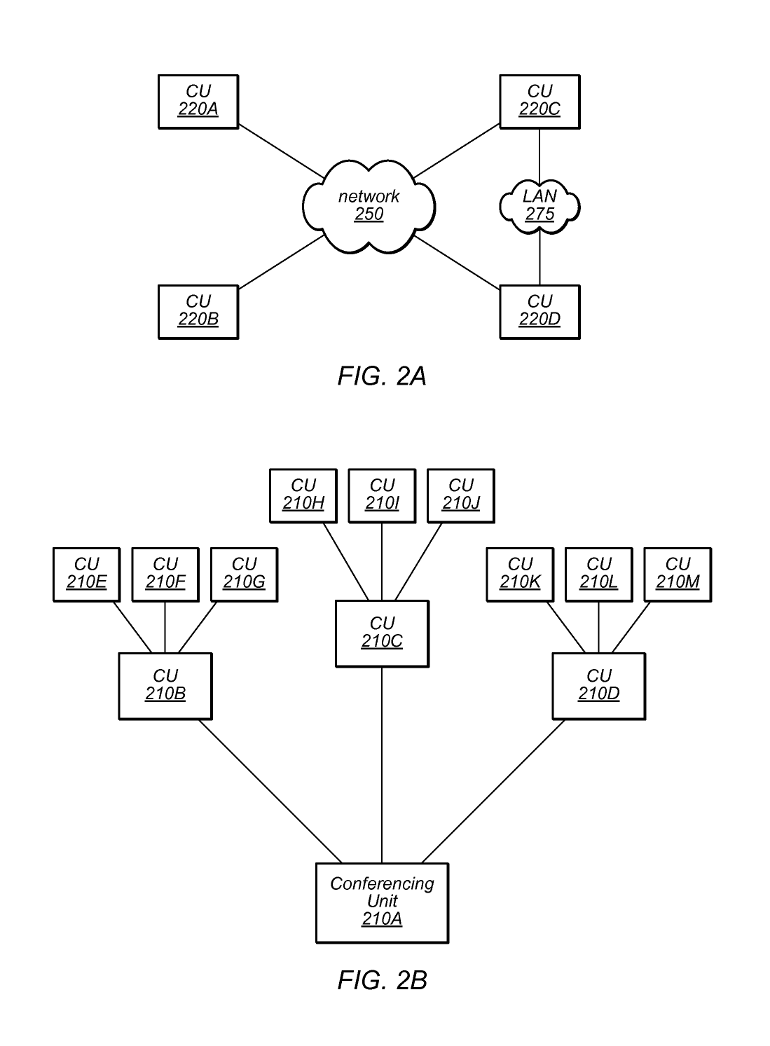

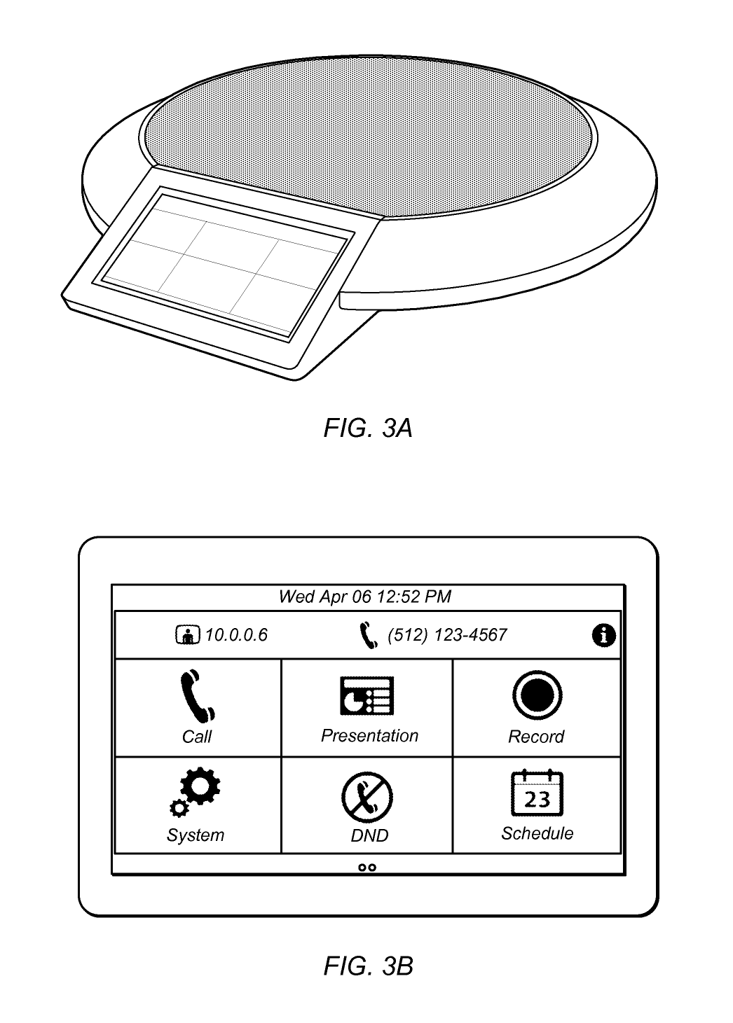

In some embodiments, the videoconferencing system components (e.g., the camera 104, display 101, sound system 161, and speakerphones 105/107) may be coupled to a system codec 109. The system codec 109 may be placed on a desk or on the floor. Other placements are also contemplated. The system codec 109 may receive audio and/or video data from a network, such as a LAN (local area network) or the Internet. The system codec 109 may send the audio to the speakerphone 105/107 and/or sound system 161 and the video to the display 101. The received video may be HD video that is displayed on the HD display. The system codec 109 may also receive video data from the camera 104 and audio data from the speakerphones 105/107 and transmit the video and/or audio data over the network to another conferencing system, or to an MCU for provision to other conferencing systems. The conferencing system may be controlled by a participant or user through various mechanisms, such as a touch interface described herein. The touch interface may be implemented as a remote control, as a portion of the speakerphones 107 and/or 105, and/or in any other desired manner. FIGS. 2 and 3 provide exemplary embodiments of such an interface.

In various embodiments, the codec 109 may implement a real time transmission protocol. In some embodiments, the codec 109 (which may be short for “compressor/decompressor” or “coder/decoder”) may comprise any system and/or method for encoding and/or decoding (e.g., compressing and decompressing) data (e.g., audio and/or video data). For example, communication applications may use codecs for encoding video and audio for transmission across networks, including compression and packetization. Codecs may also be used to convert an analog signal to a digital signal for transmitting over various digital networks (e.g., network, PSTN, the Internet, etc.) and to convert a received digital signal to an analog signal. In various embodiments, codecs may be implemented in software, hardware, or a combination of both. Some codecs for computer video and/or audio may utilize MPEG, Indeo™, and Cinepak™, among others.

In some embodiments, the videoconferencing system 103 may be designed to operate with normal display or high definition (HD) display capabilities. The videoconferencing system 103 may operate with network infrastructures that support T1 capabilities or less, e.g., 1.5 mega-bits per second or less in one embodiment, and 2 mega-bits per second in other embodiments.

Note that the videoconferencing system(s) described herein may be dedicated videoconferencing systems (i.e., whose purpose is to provide videoconferencing) or general purpose computers (e.g., IBM-compatible PC, Mac, etc.) executing videoconferencing software (e.g., a general purpose computer for using user applications, one of which performs videoconferencing). A dedicated videoconferencing system may be designed specifically for videoconferencing, and is not used as a general purpose computing platform; for example, the dedicated videoconferencing system may execute an operating system which may be typically streamlined (or “locked down”) to run one or more applications to provide videoconferencing, e.g., for a conference room of a company. In other embodiments, the videoconferencing system may be a general use computer (e.g., a typical computer system which may be used by the general public or a high end computer system used by corporations) which can execute a plurality of third party applications, one of which provides videoconferencing capabilities. Videoconferencing systems may be complex (such as the videoconferencing system shown in FIG. 1) or simple (e.g., a user computer system with a video camera, input devices, microphone and/or speakers). Thus, references to videoconferencing systems, endpoints, etc. herein may refer to general computer systems which execute videoconferencing applications or dedicated videoconferencing systems. Note further that references to the videoconferencing systems performing actions may refer to the videoconferencing application(s) executed by the videoconferencing systems performing the actions (i.e., being executed to perform the actions).

The videoconferencing system 103 may execute various videoconferencing application software that presents a graphical user interface (GUI) on the display 101. The GUI may be used to present an address book, contact list, list of previous callees (call list) and/or other information indicating other videoconferencing systems that the user may desire to call to conduct a videoconference. The GUI may also present options for recording a current videoconference, and may also present options for viewing a previously recorded videoconference.

Note that the videoconferencing system shown in FIG. 1 may be modified to be an audioconferencing system. For example, the audioconference could be performed over a network, e.g., the Internet, using VoIP. The audioconferencing system, for example, may simply include speakerphones 105/107 and the touch interface described herein, although additional components may also be present. Additionally, note that any reference to a “conferencing system” or “conferencing systems” may refer to videoconferencing systems or audioconferencing systems (e.g., teleconferencing systems). In the embodiments described below, the conference is described as a videoconference, but note that the methods may be modified for utilization in an audioconference.

FIGS. 2A and 2B—Coupled Conferencing Systems

FIGS. 2A and 2B illustrate different configurations of conferencing systems. The conferencing systems may be operable to perform the methods described herein. As shown in FIG. 2A, conferencing systems (CUs) 220A-D (e.g., videoconferencing systems 103 described above) may be connected via network 250 (e.g., a wide area network such as the Internet) and CU 220C and 220D may be coupled over a local area network (LAN) 275. The networks may be any type of network (e.g., wired or wireless) as desired.

FIG. 2B illustrates a relationship view of conferencing systems 210A-210M. As shown, conferencing system 210A may be aware of CU 210B-210D, each of which may be aware of further CU's (210E-210G, 210H-210J, and 210K-210M respectively). CU 210A may be operable to perform the methods described herein. In a similar manner, each of the other CUs shown in FIG. 2B, such as CU 210H, may be able to perform the methods described herein, as described in more detail below. Similar remarks apply to CUs 220A-D in FIG. 2A.

FIGS. 3A and 3B—Exemplary Touch Interface

FIG. 3A illustrates an exemplary touch interface and FIG. 3B illustrates an exemplary speaker phone with a touch interface. In the embodiment of FIG. 3A, the touch interface may be used as a remote control for a videoconferencing system, such as the videoconferencing system of FIG. 1. In the embodiment of FIG. 3B, the touch interface may be integrated in a phone, such as a speaker phone, or in some embodiments, a participant's personal device. In this embodiment, the touch interface may replace the typical physical button interface of the speaker phone, although additional physical buttons may also be present. Similarly, while the touch interface of FIG. 3A does not include physical buttons, embodiments are envisioned where physical buttons are also included. In some embodiments, the touch interface of FIG. 3B may be removable from the speaker phone (e.g., resulting in the touch interface of FIG. 3A), so that a user may separate the touch interface from the phone and use it as a remote control. The videoconferencing system of FIG. 1 may include a single touch interface (integrated in a speaker phone or not), or may include a plurality of touch interfaces (e.g., integrated with each of the speakerphones of the videoconferencing system). Additionally, the touch interface may be an explicit component of the videoconferencing system (e.g., as a speakerphone) or may be separate, but usable with the videoconferencing system. For example, a user's tablet or smart phone could be used as the (or one of the) touch interfaces of the videoconference.

In further embodiments, the touch interface (e.g., especially for the embodiment of FIG. 3B) may be usable outside of (or independently from) the videoconferencing system. For example, the touch interface may be used to perform audioconferencing without using all (or some of) the various additional components of the videoconferencing system. Thus, in one embodiment, the speaker phone of FIG. 3B may be used to perform audioconferencing.

As shown in these Figures, the touch interface may be a touch display that is configured to display graphics on the display as well as receive touch input. For example, as shown, the touch display may display a graphical user interface. For example, a user may be able to select, via touch input, various icons or graphical buttons displayed in the graphical user interface to perform videoconferencing actions.

A user may be able to provide gestures to the touch interface to perform videoconferencing actions. As used herein, a “gesture” refers to a touch interaction with a touch interface. A gesture may include the use of one finger (or digit), two fingers (e.g., to perform two simultaneous touches), three fingers, four fingers, five fingers, etc. A gesture involving one touch (e.g., by a single finger or digit) may be referred to as a “single-touch gesture” and a gesture involving more than one touch (e.g., by a plurality of fingers or digits) may be referred to as a “multi-touch gesture”. Generally, a gesture is begun by initiating a touch and is ended when the touch is no longer present (e.g., when there is no longer any touch on the touch interface or when the initial touch is no longer on the touch interface).

Exemplary gestures include a single touch (e.g., a “tap” with a single finger), a double touch (e.g., a “double tap” with a single finger), a two finger touch (e.g., a “tap” using two fingers simultaneously), a three finger touch, a four finger touch, a five finger touch, an expansion gesture (e.g., a “reverse pinch” or “spread” where two touches are initiated and then the distance between the two touches are increased while both remain in contact with the touch interface, although more than two touches may be used, e.g., with three touches where at least one touch moves away from the other two touches), a minimization gesture (e.g., a “pinch” where two touches are initiated and then the distance between two touches are decreased while both remain in contact with the touch interface, although more than two touches are envisioned), a “drag” or “slide” gesture using one or more touches (e.g., where a single touch is initiated, then moved some distance along the touch interface, and then released), a “flick” gesture using one or more touches (e.g., where a touch is initiated and then quickly moved along the touch interface and released), a “press” gesture (e.g., where one or more touches are initiated and then held for a threshold amount of time, longer than a tap gesture), a “press and tap” gesture (e.g., where one or more touches are “pressed” and then a second one or more touches are “tapped”). In some embodiments, gestures may include drawing or outlining. For example, a user may provide a gesture by touching the touch interface and then drawing a shape (e.g., an “L”, backwards “L”, a circle, a square, or any type of shape or sequence of lines). The user may create the shape using any number of simultaneous touches (e.g., using one finger, using two fingers, etc.) and each may be distinguishable from the next based on the number of touches and drawn shape. Thus, gestures may include outlines or drawings of shapes. Generally, gestures described herein are more complex than simple single touch tap gestures. These gestures may be referred to as “complex gestures”. Accordingly, as used herein, a “complex gesture” is any gesture other than (or more complex than) a single touch tap. Generally, a complex gesture includes a single touch and additional touch input (e.g., such as another touch for a two touch tap, additional movement for a drag, increased time for a “touch and hold” gesture, etc.). Additionally, any instance of a “gesture” used herein may refer to a “complex gesture”.

In one embodiment, the gestures may be provided to a portion of the touch interface that is dedicated to gestures or may be provided in response to selecting a gestures button (e.g., in order to indicate to the touch interface that the user wishes to provide a gesture). However, in alternate embodiments, the gestures may be provided over the graphical interface (e.g., the location of the gesture may not matter). In such embodiments, the gestures may be used to indicate or perform a videoconferencing action that is not indicated in the graphical user interface. More specifically, the gestures may indicate the videoconferencing action independent from what is displayed on the touch display. Alternatively, the context that the gesture is provided in may matter. For example, a gesture may be used for a plurality of different videoconferencing actions, depending on the context of the gesture (e.g., which particular user interface the gesture was provided in, whether a videoconference was ongoing, etc.). In further embodiments, the touch interface may not include a display, and gestures may simply be provided to the touch interface.

Thus, a user may be able to interact with or control a videoconference using the touch interface of FIGS. 3A and 3B.

In further embodiments, the touch interface may provide features in addition to the controlling videoconference. For example, the touch interface may be used to display video of the videoconference (e.g., duplicating video that is displayed on the videoconferencing system's display or video that is not provided for display in the videoconferencing system). When displaying video, the touch interface may provide the video at a lower resolution and/or frame rate than the videoconference display(s) (e.g., which may operate at high definition). For example, the touch interface may display at a 5-10 frames per second (fps), although other frame rates are envisioned.

In one embodiment, the touch interface may be used to display a presentation while the videoconference display provides video of participants of the videoconference. For example, a user may be able to upload a presentation to the touch interface and then control the presentation via the touch interface. In another embodiment, a user may select to view a presentation provided by another user on the touch interface. Alternatively, the touch interface may be used to display video of participants, e.g., while a presentation is provided for display on the videoconference display(s). Any type of video may be provided for display on the touch interface, as desired.

Additionally, the touch interface (whether combined with the speaker phone as in FIG. 3B, or not, may be used as a mini videoconferencing system. For example, a user may be able to perform an audioconference using the speakerphone and then provide a presentation during the audio conference by using the touch interface, e.g., after using a USB thumb drive to upload the presentation to the touch interface. Thus, the touch interface may be configured to provide a video stream of the presentation to other participants, thereby acting as a videoconferencing system. Similarly, a camera may be used (e.g., integrated with the touch interface or speakerphone) and accordingly, the images captured by the camera may be provided to other participants of the videoconference. Thus, the touch interface may be used as a mini videoconferencing system in addition to acting as a component of the videoconferencing system, such as that shown in FIG. 1. Note that video may take a lower priority than audio in such an embodiment.

Further details regarding the touch interface and controlling a videoconference can be found in U.S. patent application Ser. No. 13/171/292, which was incorporated by reference in its entirety above.

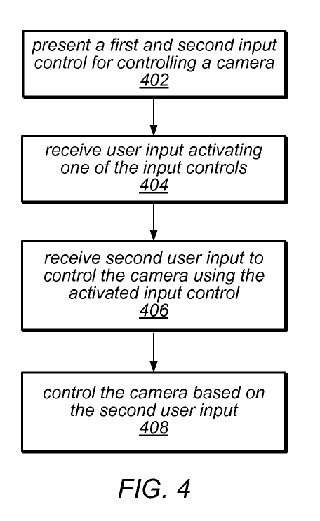

FIG. 4—Controlling a Videoconference Using a Touch Interface

FIG. 4 illustrates a method for controlling a videoconference using a touch interface. The method shown in FIG. 4 may be used in conjunction with any of the computer systems or devices shown in the above Figures, among other devices. In various embodiments, some of the method elements shown may be performed concurrently, performed in a different order than shown, or omitted. Additional method elements may also be performed as desired. As shown, this method may operate as follows.

In 402, a first input control and a second input control may be presented on the touch display. For example, each input control may be represented by an icon (e.g., a circular icon) on the touch display. The first input control may be configured to control pan and tilt of the camera while the second input control may be configured to control zoom of the camera.

In some embodiments, the camera being controlled may have been previously selected from a plurality of available camera for control. For example, a user interface may have been displayed on the touch display for selecting a camera to control and user input may be received to the user interface to select the camera. The list of available cameras may include one or more local cameras (e.g., at the same location as the touch display) and/or one or more remote cameras (e.g., provided at remote locations, such as in other videoconferencing endpoints participating in a videoconference). Accordingly, the first and second input controls may be presented in response to the selection of the camera. Note that the camera controls may be presented during a videoconference or at other times, as desired.

Each of the first input control and the second input control may include a first region for activating the respective control. For example, the first region may be the interior of the input control's icon. In some embodiments, the first region may be all of the interior of the input control icon or may be a subset of the interior (e.g., the centermost 50% the icon), as desired. Additionally, after activation (e.g., via the user touching and holding contact within the first region), the input controls may include a second region for performing camera control, e.g., controlling the pan and tilt or zoom of the camera, depending on the activated input control. In one embodiment, user input to the second regions may not perform any action unless the input control has been activated. Similarly, user input to the second regions may not perform any action if the input control has been deactivated. Thus, in one embodiment, the second regions may only receive input to perform camera control while the selected input control is activated. In some embodiments, the second region may be the area immediately exterior to the first region (e.g., outside of the icon representing the control). The second region may only extend a certain amount from the first region (e.g., the area of the second region may be 50% or 100% more than the first region) or may be any region outside of the first region, as desired.

The second region may include a plurality of subregions for performing the particular camera control functions associated with the input control. For example, the first input control may have four subregions: two for controlling pan (e.g., extending to the left and right from the first region, respectively) and two for controlling tilt (e.g., extending up and down from the first region, respectively). In a further example, the first input control may have more than four subregions, e.g., eight subregions, where subregions between the cardinal subregions are used to control both pan and tilt at the same time. In a slightly different embodiment, the four subregions may overlap, such that the same effect is achieved.

Similarly, for the second input control, there may be two subregions for controlling zoom of the camera, e.g., extending up and down from the first region, respectively, or extending left and right from the first region, respectively. The subregions of the second region may be contiguous (that is, the subregions may all directly border each other and their combined area may be the same as the second region's area) or they may not (e.g., where the second region includes “dead” areas between the subregions which do not activate camera control), as desired.

Accordingly, in 404, first user input may be received to the touch display to activate one of the inputs controls. For example, to activate one of the controls, the user may provide the user input to the first region of the input control. In one particular embodiment, to activate the input control, the user may touch the first region (e.g., with a single touch) of the input control and remain touching the touch display. In such an embodiment, the input control may remain activated while the user remains touching the touch display and stays within the first region and/or the second region of the input control. Thus, in this embodiment, the input control may be deactivated if the user ceases touching the touch display and also may be deactivated if the user's touch input moves outside of the first and second regions of the selected input control. Alternatively, the input control may remain activated while the touch continues and may not be dependent on the particular location of the touch. However, this particular activation/deactivation embodiment is exemplary only and others are envisioned. For example, a single touch may activate the control and then later input could be received to the second regions after activation. Additionally, various gestures may be used to activate or deactivate the input controls, as desired.

When activated, a visual indication that the input control is activated may be provided on the touch display. For example, the touch display may visually indicate that the selected input control has been activated by modifying the icon representing the selected input control. In one embodiment, this may be indicated by highlighting the icon or otherwise modifying the icon's appearance (e.g., enlarging the icon, animating the icon, etc.). In addition, other visual indicators may be displayed on the touch display, such as additional icons (e.g., a selection icon indicating that the input control is activated). Further, visual indicators of the second region (e.g., the subregions of the second region) may be provided on the touch display, e.g., in order to instruct the user on how to perform the camera control using the second region. For example, arrows or other icons may be displayed within the subregions to indicate the actions that may be performed in response to touches to those subregions.

After receiving the first user input, in 406, second user input may be received to the touch display to the second region of the selected input control. More specifically, the second user input may be received to one or more of the subregions of the second region. For example, when using the first input control, the user may wish to pan the camera left and tilt the camera down—accordingly, the second user input may be received first to the left subregion and then to the down subregion (although one or more of these may be the opposite, depending on whether input inversion is used). Similarly, the user may provide input to the second input control for controlling the zoom or magnification of the camera.

Note that the first and second user input may be continuous input (where the touch is not released), e.g., following the embodiment described above. However, as also indicated above, disparate inputs are also envisioned, e.g., for other activation/deactivation embodiments, as desired. Similarly, the second input to the subregions may comprise a single continuous input (e.g., where the user does not lift or cancel the initial touch) or may comprise several disparate inputs (e.g., to each subregion), as desired.

Accordingly, in 408, based on the second user input, the pan and tilt or the zoom of the camera may be adjusted, depending on which of the first input control or the second input control is selected. Since the second user input may be continuous (e.g., selecting a first subregion and then a second subregion), the adjustment of the camera may be performed similarly, e.g., reacting as soon as the touch input is within a subregion.

In some embodiments, the camera may be controlled in a linear fashion, where each increment of time for a touch results in a similar level of adjustment. However, different relationships are envisioned, e.g., where the level of adjustment increases over time (e.g., where the rate of change in the camera control function increases the longer the touch is held in a subregion), where the level of adjustment decreases over time, where the level of adjustment is based on the camera's current position relative to its extrema (e.g., where zooming slows down as it approaches its maximum or minimum zoom), etc.

In another embodiment, the rate of control (e.g., pan or zoom) may be determined based on the distance of the current position of the touch from the input control (e.g., the center of the input control). For example, the rate of control may increase as the distance increases. In one embodiment, the rate and distance may be related according to a linear function, exponential function, or any desired relationship. Thus, any type of responsiveness for the adjustment is envisioned.

Additionally, in one embodiment, any change in direction of the touch may cause a corresponding change in direction of the camera (e.g., without having to pass back through the input control (e.g., the center or first region of the input control).

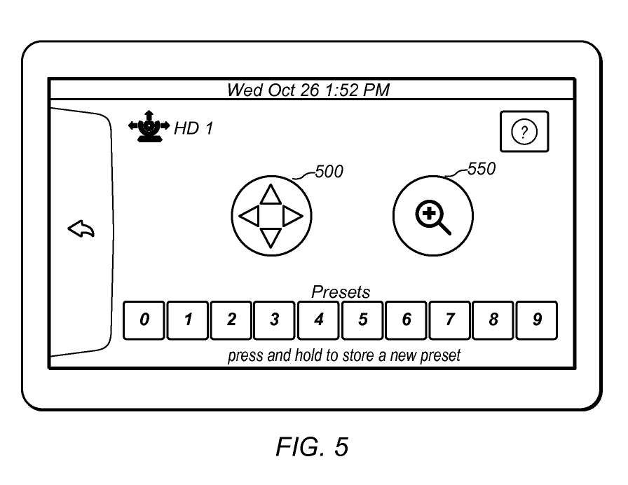

FIGS. 5-7H—Exemplary Interfaces of a Touch Display

FIGS. 5-7H are exemplary graphical user interfaces which correspond to one embodiment of the method of FIG. 4. These graphical user interfaces are provided only as an exemplary user interface and do not limit any of the embodiments described above.

FIG. 5 illustrates an exemplary user interface for controlling a camera. As shown in this user interface, two input controls may be displayed as icons, input control 500 for controlling pan and tilt of the camera (as indicated by the four arrow icons within the input control 500) and input control 550 for controlling zoom of the camera (as indicated by the magnification icon within the input control 550). This particular interface is being used to control camera “HD 1”, but could be used to control any of the available cameras, e.g., local, for near end camera control, or remote, for far end camera control, as desired.

These input controls may be activated by providing touch user input to them. More specifically, in one embodiment, the input controls may be activated whenever a touch is begun within a first region of the input control and not released. In the embodiment of FIG. 5, the first region may be any portion within the icon (i.e., within the circle) of the input control. However, other embodiments are envisioned where the first region is smaller than the portion (e.g., within the circle).

In addition to the input controls, the user interface of FIG. 5 also includes icons corresponding to camera presets. More specifically, the user may select these presets by touching the corresponding icon (e.g., selecting icon “0” to activate the camera preset 0, and so one). In addition, as indicated by the text in the user interface, a user may “press and hold [a preset icon] to store a new preset”. Finally, the user may return to the previous user interface (e.g., to select the camera being controlled) or get help by providing input to the back button (on the left) or the help button (on the top right).

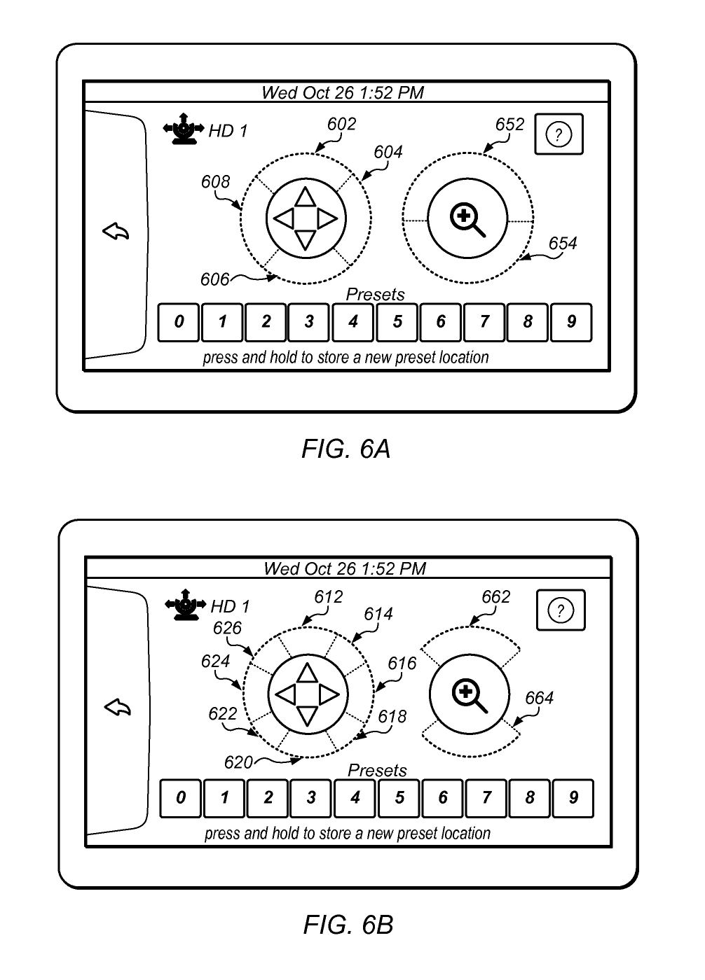

FIGS. 6A and 6B illustrate two different embodiments of second regions of the two input controls. These second regions may be active or available for input after activating the corresponding input controls, as discussed above.

As shown in FIG. 6A, the input control 500 may include a second region having four contiguous subregions: 602, 604, 606, and 608. Subregion 602 may be used to tilt the camera up, 604 may be used to pan the camera right, 606 may be used to tilt the camera down, and 608 may be used to pan the camera left, although other embodiments are envisioned, e.g., where vertical and/or horizontal inversion is used. As also shown in FIG. 6A, the input control 550 may include a second region having two contiguous subregions: 652 and 654. Subregion 652 may be used to zoom the camera in (or increase magnification) and subregion 654 may be used to zoom the camera out (or decrease magnification).

FIG. 6B illustrates alternate embodiments of the second regions for the input controls 500 and 550. More specifically, in FIG. 6B, the input control 500 includes eight contiguous subregions: 612, 614, 616, 618, 620, 622, 624, and 626. Subregions 612, 616, 620, and 624 may have the same functionality as 602, 604, 606, and 608, respectively. However, subregions 614, 618, 622, and 626 may combine the functionality of their neighboring subregions. More specifically, 614 may be used to tilt the camera up and pan right at the same time, 618 may be used to tilt the camera down and pan right at the same time, 622 may be used to tilt the camera down and pan left at the same time, and 626 may be used to tilt the camera up and pan left at the same time. As also shown in FIG. 6B, the input control 550 may include a second region having two noncontiguous subregions: 662 and 664. These subregions may have the same functionality as 652 and 654, except that they are smaller in area and noncontiguous. Accordingly, input outside of these subregions may not result in any action.

Further embodiments are envisioned for the second regions. For example, where the first region does not extend through the entire area of the input control icons, the second region may correspondingly exist inside the input control icons, either completely or partially. Generally, the second region may border and extend outward from the first region. Additionally, horizontal subregions are envisioned for input control 550. Further the size of the second regions may be larger or smaller as desired.

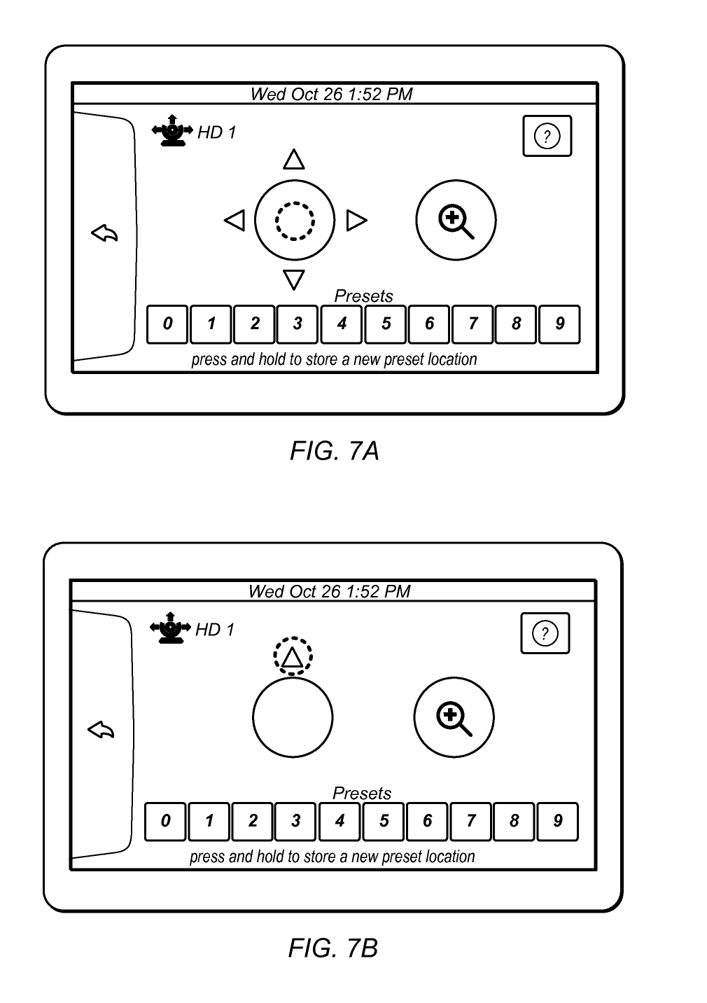

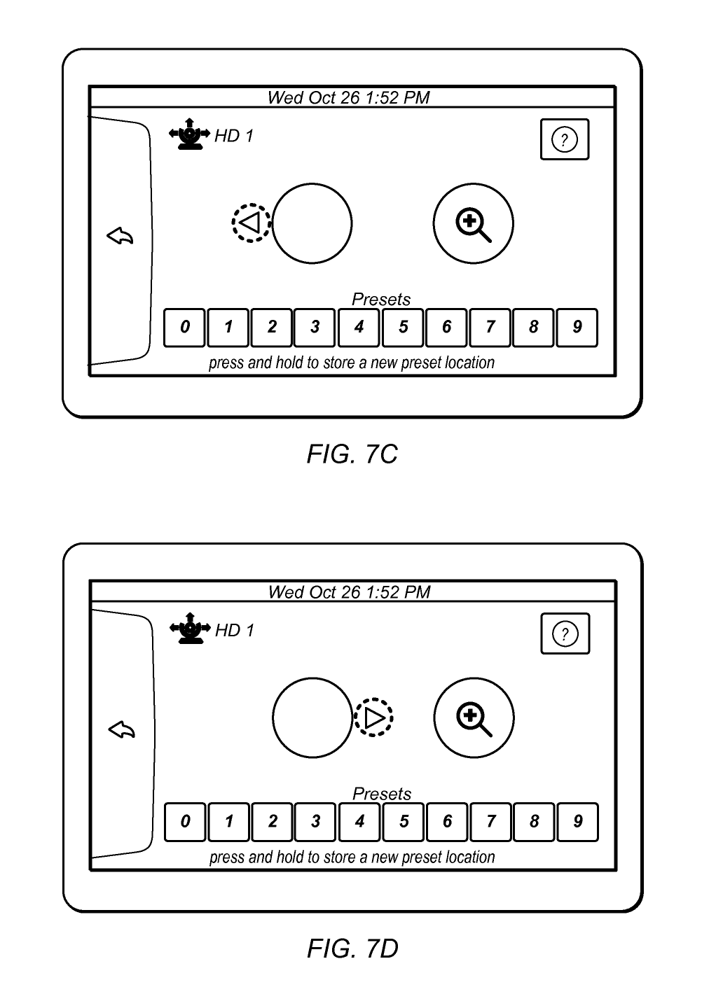

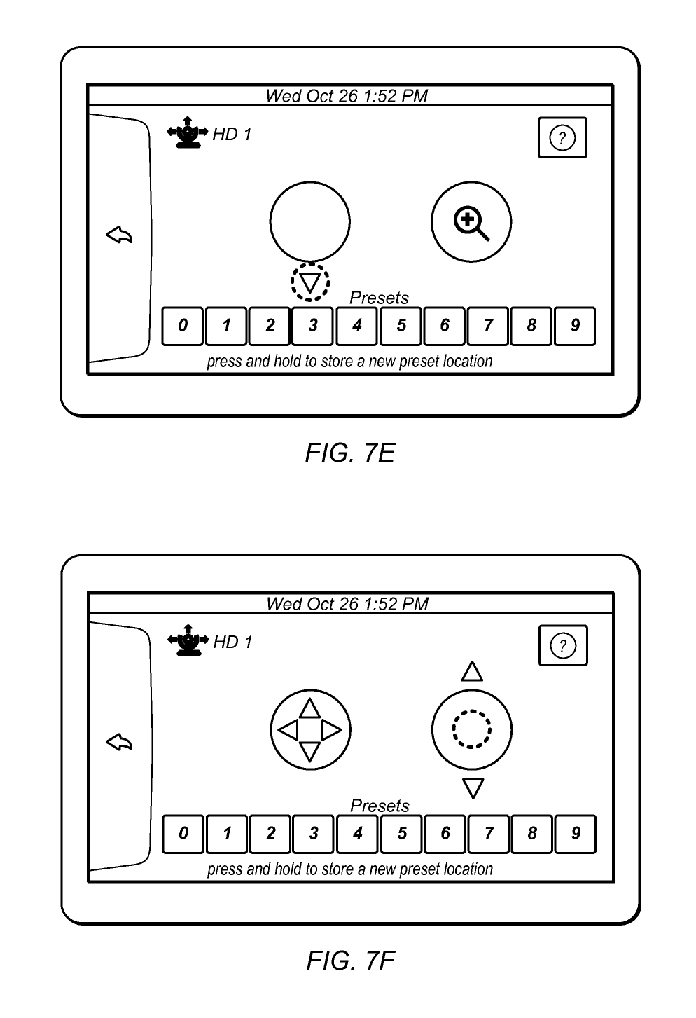

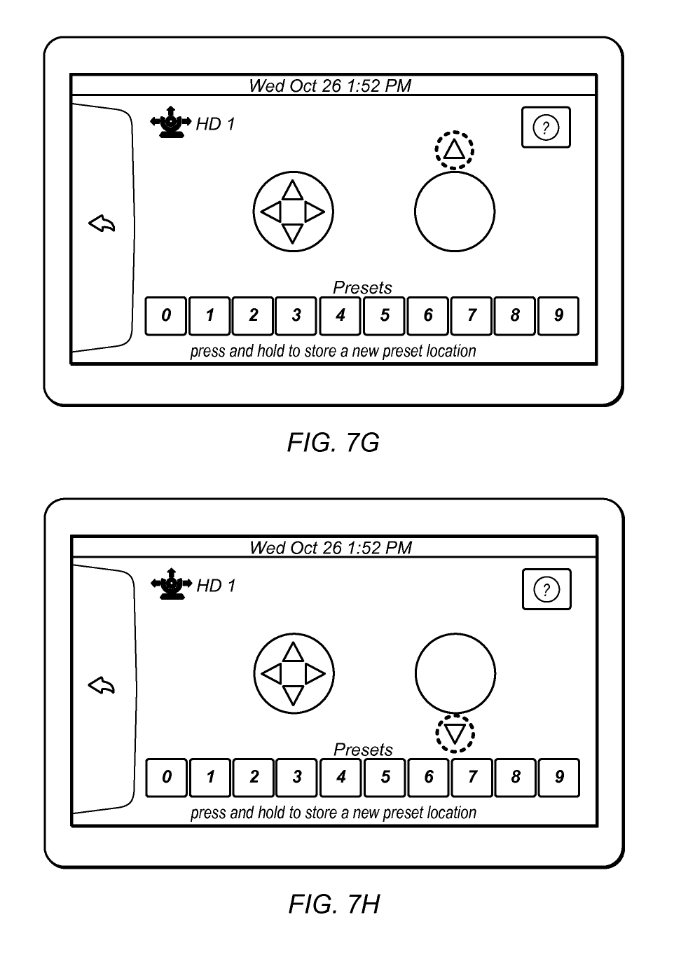

FIGS. 7A-7H illustrate the interface of FIG. 5 along with touch input indications. More specifically, as shown in FIG. 7A, touch input (indicated by the dotted line circle) is provided to the input control 500. As shown, the central icon within the input control 500 is no longer displayed and arrow icons are newly displayed outside of the first region (within the second region, similar to FIG. 6A) indicating where to move the touch input to cause a change in camera pan. In one embodiment, an animation may be used to cause this change in appearance, such as the arrows expanding outward from the center in response to the touch input. In the following FIGS. 7B-7E), the touch input is not released, although other embodiments where the input controls are used with more than one touch are also envisioned.

In FIG. 7B, the touch has been moved upward into the top subregion of the second region. Accordingly, the tilt of the camera may be adjusted upwards. As is also shown, the up arrow icon remains while the left, right, and bottom arrows disappear, indicating the input is being provided to cause the camera to pan upwards (or downwards, if inverted). This change in appearance may provide visual feedback to the user regarding how the input is currently being detected by the touch display. Similarly, in FIGS. 7C-7E, the user has provided touch input to pan left, pan right, and tilt down, respectively. In each of these Figures, the icons are displayed based on how the input is being detected (i.e., the bottom arrow icon is displayed when the camera is panning down, left for left panning, right for right panning, etc.) and/or where the input is being provided, as desired.

In FIG. 7F, touch input is provided to the input control 550. Similar to the previous Figures, the magnification icon disappears from the input control 550 and an up arrow icon is displayed above the first region of the input control 550 (e.g., for zooming in) and a down arrow icon is displayed below the first region of the input control 550 (e.g., for zooming out). In FIGS. 7G and 7H, the user provides input to zoom in and zoom out by providing input to the top and bottom subregions of the second region, respectively. Similar to previous Figures, arrow icons are only displayed in the corresponding regions during the input. However, alternate embodiments are envisioned where this is not the case (e.g., where the arrow icons remain and/or an animation is used to indicate where the action or input is being provided).

### Further Embodiments

While the embodiments discussed above focus on camera control within the context of videoconferencing, they may be applied to any application where camera control or device control is desirable. For example, such an interface may be used to perform control of cameras, e.g., for filming or production, or even to perform remote control of surgical devices, robots, etc. Thus, the embodiments discussed above are not merely limited to the control of cameras in videoconferencing, but can be extended to a plethora of other applications.

Embodiments of a subset or all (and portions or all) of the above may be implemented by program instructions stored in a memory medium or carrier medium and executed by a processor.

In some embodiments, a computer system at a respective participant location may include a memory medium(s) on which one or more computer programs or software components according to one embodiment of the present invention may be stored. For example, the memory medium may store one or more programs that are executable to perform the methods described herein. The memory medium may also store operating system software, as well as other software for operation of the computer system.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A method for controlling a camera, the method comprising:
presenting a first input control and a second input control on a touch display, wherein the first input control is configured to control pan and tilt of the camera, wherein the second input control is configured to control zoom of the camera, wherein each of the first input control and the second input control comprise a first region for activating the respective control, wherein, after activation, each of the first input control and the second input control comprise a second region for controlling the pan and tilt or zoom of the camera, depending on the activated input control;
receiving first user input to the touch display to the first region of one of the first input control or the second input control;
after receiving the first user input, receiving second user input to the touch display to the second region of the one of the first input control or the second input control, wherein the second user input is received to adjust the pan and tilt or zoom of the camera, depending on which of the first input control or the second input control is selected;
adjusting the pan and tilt or the zoom of the camera in response to the second user input, depending on which of the first input control or the second input control is selected.

2. The method of claim 1, wherein the first user input and the second user input are received in a continuous manner.

3. The method of claim 1, wherein after providing the second user input, the second region of the one of the first input control or the second input control is deactivated until the input to the first region is received.

4. The method of claim 1, wherein the first user input selects the first input control, wherein the second user input is received to control the pan and tilt of the camera, and wherein said adjusting adjusts the pan and tilt of the camera in response to the second user input.

5. The method of claim 4, wherein the second region of the first input control comprises four subregions for indicating pan left, pan right, tilt up, and tilt down, wherein the second user input is received to one or more of the four subregions.

6. The method of claim 1, wherein the first user input selects the second input control, wherein the second user input is received to control the zoom of the camera, and wherein said adjusting adjusts the zoom of the camera in response to the second user input.

7. The method of claim 6, wherein the second region of the second input control comprises two subregions for indicating zoom in and zoom out, wherein the second user input is received to one or more of the two subregions.

8. The method of claim 1, further comprising:
visually modifying the one of the first input control or the second input control on the touch display in response to receiving the first user input, wherein said visually modifying indicates the second region of the one of the first input control or the second input control on the touch display.

9. The method of claim 8, wherein said visually modifying indicates subregions of the second region for controlling the camera.

10. The method of claim 1, further comprising:
displaying a plurality icons corresponding to camera presents on the touch display;
receiving third user input to the touch display selecting a first icon of the plurality of icons, wherein the first icon corresponds to a first camera preset;
adjusting the pan and/or zoom of the camera based on a first camera preset.

11. A non-transitory, computer accessible memory medium storing program instructions for controlling a camera, wherein the program instructions are executable to:
present a first input control on a touch display, wherein the first input control is configured to control pan and tilt of the camera, wherein the first input control comprises a first region for activating the respective control, wherein, after activation, the first input control comprises a second region for controlling the pan and tilt of the camera;
present a second input control on the touch display, wherein the second input control is configured to control zoom of the camera, wherein the second input control comprises a first region for activating the respective control, wherein, after activation, the second input control comprises a second region for controlling the zoom of the camera;
adjust operation of the camera in response to user input to at least one of the first input control or the second input control.

12. The non-transitory, computer accessible memory medium of claim 11, wherein the program instructions are further executable to:
receive first user input to the touch display to the first region of the first input control;
after receiving the first user input, receive second user input to the touch display to the second region of the first input control, wherein the second user input is received to adjust the pan and tilt of the camera;
adjust the pan and tilt of the camera in response to the second user input.

13. The non-transitory, computer accessible memory medium of claim 12, wherein the first user input and the second user input are received in a continuous manner.

14. The non-transitory, computer accessible memory medium of claim 12, wherein the second region of the first input control comprises four subregions for indicating pan left, pan right, tilt up, and tilt down, wherein the second user input is received to one or more of the four subregions.

15. The non-transitory, computer accessible memory medium of claim 11, wherein the program instructions are further executable to:
receive first user input to the touch display to the first region of the second input control;
after receiving the first user input, receive second user input to the touch display to the second region of the second input control, wherein the second user input is received to adjust the zoom of the camera;
adjust the zoom of the camera in response to the second user input.

16. The non-transitory, computer accessible memory medium of claim 15, wherein the first user input and the second user input are received in a continuous manner.

17. The non-transitory, computer accessible memory medium of claim 16, wherein the second region of the second input control comprises two subregions for indicating zoom in and zoom out, wherein the second user input is received to one or more of the two subregions.

18. The non-transitory, computer accessible memory medium of claim 11, wherein the program instructions are further executable to:
visually modify one of the first input control or the second input control on the touch display in response to receiving the user input, wherein said visually modifying indicates the second region of the one of the first input control or the second input control on the touch display.

19. The non-transitory, computer accessible memory medium of claim 18, wherein said visually modifying indicates subregions of the second region for controlling the camera.

20. The non-transitory, computer accessible memory medium of claim 11, wherein the program instructions are further executable to:
display a plurality icons corresponding to camera presents on the touch display;
receive third user input to the touch display selecting a first icon of the plurality of icons, wherein the first icon corresponds to a first camera preset;
adjust the pan and/or zoom of the camera based on a first camera preset.

21. A videoconferencing system, comprising:
a videoconferencing unit at a participant location;
at least one display coupled to the videoconferencing unit, wherein the at least one display is configured to provide video corresponding to other participant locations during a videoconference;
at least one audio output coupled to the videoconferencing unit, wherein the at least one audio output is configured to provide audio corresponding to the other participant locations during the videoconference;
at least one video input coupled to the videoconferencing unit, wherein the at least one video input is configured to capture video of the participant location for provision to the other participant locations;
at least one audio input coupled to the videoconferencing unit, wherein the at least one audio input is configured to capture audio of the participant location for provision to the other participant locations;
at least one touch display coupled to the videoconferencing unit, wherein the at least one touch display is configured to receive touch input to control a first camera;
wherein the videoconferencing system is configured to:
present a first input control and a second input control on the touch display, wherein the first input control is configured to control pan and tilt of the first camera, wherein the second input control is configured to control zoom of the first camera, wherein each of the first input control and the second input control comprise a first region for activating the respective control, wherein, after activation, each of the first input control and the second input control comprise a second region for controlling the pan and tilt or zoom of the first camera, depending on the activated input control;
receive first user input to the touch display to the first region of one of the first input control or the second input control;
after receiving the first user input, receive second user input to the touch display to the second region of the one of the first input control or the second input control, wherein the second user input is received to adjust the pan and tilt or zoom of the first camera, depending on which of the first input control or the second input control is selected;
adjust the pan and tilt or the zoom of the first camera in response to the second user input, depending on which of the first input control or the second input control is selected.

22. The system of claim 21, wherein the first camera is comprised in the at least one video input.

23. The system of claim 21, wherein the first camera is comprised in a second videoconferencing system at a second location, wherein said adjusting comprises providing messages to the second videoconferencing system to perform said adjusting.
